(19) United States
(12) Patent Application Publication
(10) Pub. No.: US 2014/0262888 A1
(43) Pub. Date: Sep. 18, 2014

(54) PALLET LOADING SYSTEMS AND METHODS

(71) Applicant: Jiajing USA, Inc., Richmond (CA)

(72) Inventor: Gary M. Wahrmund, Fort Worth, TX (US)

(21) Appl. No.: 14/213,296

(22) Filed: Mar. 14, 2014

Related U.S. Application Data
(60) Provisional application No. 61/791,917, filed on Mar. 15, 2013.

(51) Int. Cl. B65G 57/22; B65B 63/04; B65D 19/00; B65B 5/04

(52) U.S. Cl. CPC B65G 57/22; B65B 5/04; B65B 63/04; B65D 19/0004
USPC 206/386; 53/429; 414/802

(57) ABSTRACT

Improved system and method embodiments of transporting and displaying boxed products, such as compressible bedding products, are disclosed. For example, by selecting box size, shape, and orientation appropriately, product density on a pallet may be increased. In some instances, the ability to alter box size and shape may arise due to the compressible nature of products; for example, by compressing the products prior to rolling and insertion into boxes, the box dimensions available for embodiment may be altered. Some systems and methods may also apply to boxed products on shelving or other surfaces.

### CROSS-REFERENCE TO RELATED APPLICATIONS

This application is related as a non-provisional of and claims benefit under 35 U.S.C. §119 to U.S. Provisional Patent Application Ser. No. 61/791,917 entitled “Pallet Loading Systems and Methods” and filed Mar. 15, 2013, which is assigned to the Assignee of the present application and hereby incorporated by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Typically, much of the transportation of goods within the United States takes place using trucking, with big rig eighteen wheelers moving boxes of goods, for example. Often, the boxed goods are packed on pallets, and then loaded into the truck trailers and/or flatbeds (for example, with fork lifts moving the loaded pallets onto the trucks). Loaded pallets might also be loaded for transport on train rail cars. And while pallets are primarily used to transport packaged goods, in big box warehouse stores such as Costco and Sams Club for example, the loaded pallets may actually be placed on the floor for display and sale of goods to end user consumers for example.

Often, freight costs are based on volume rather than weight (since for example, the amount of space that pallets take up on the truck is the critical determining factor). Based on this factor, Applicant has developed systems and methods of more efficiently loading pallets to allow for more boxes of goods to be loaded onto each pallet. By packing more goods per pallet, freight costs can be reduced (since more goods can be moved by each truck for example). Furthermore, Applicant has developed improved systems and methods for displaying packaged goods on a pallet, which may be useful in increasing the sales to end user customers at big box warehouse stores for example. These and other improvements are discussed below in more detail.

### SUMMARY

Aspects of the disclosure may include embodiment of a method of loading a plurality of rectangular boxes of compressible bedding products, with each box having two square end panels and four rectangular longitudinal panels having lateral sides the same length as those of the square end panels and longitudinal sides with length greater than that of the lateral sides and each box being identically sized and shaped, onto a rectangular pallet having (a top surface and) a perimeter with longitudinal sides and lateral sides, comprising: stacking a lateral stack of boxes onto the pallet in proximity to one of the lateral sides of the pallet; stacking a plurality of longitudinal stacks of boxes onto the pallet in side-by-side (flush) configuration; wherein the longitudinal stacks are oriented so that one of the square end panels of each box on each longitudinal stack is approximately flush with the lateral stack and the longitudinal panels of each box in each stack extend perpendicularly therefrom in the longitudinal direction on the pallet; and wherein each box has longitudinal sides approximately equal in length to the lateral sides of the pallet, and each box has square end panels sized so that the length of one square end panel side of the box plus the length of one longitudinal side of the box is approximately equal to the longitudinal side length of the pallet.

Additional aspects of the disclosure may include embodiments of a pallet loading system comprising: a rectangular pallet having longitudinal sides and lateral sides; a plurality of rectangular boxes each having two square end panels with equal square sides and four rectangular longitudinal panels with lateral sides equal to the square sides in length and longitudinal sides (with length greater than the square sides), and wherein the longitudinal side length of the boxes is approximately the same as the lateral length of the pallet and the longitudinal length of the pallet is approximately the same as the longitudinal length of the boxes plus the square side length of the boxes; wherein: each box has the same shape and size (dimensions); a lateral stack of boxes is located with an outer longitudinal panel of each box in the lateral stack approximately flush in line/plane with one of the lateral side edges of the pallet; a plurality of longitudinal stacks of boxes are each located with square end panels of the boxes in each longitudinal stack approximately flush with the interior longitudinal panel of the boxes in the lateral stack and the longitudinal sides of the boxes in the longitudinal stacks extending perpendicular from the lateral stack in (i.e. along and/or parallel to) the longitudinal length of the pallet; and each of the plurality of longitudinal stacks of boxes are flush against at least one adjacent longitudinal stack of boxes (with longitudinal panels flush).

Still other aspects of the disclosure may include embodiments of a method of loading a pallet, with a surface, two longitudinal sides, and two lateral sides, with a plurality of rectangular boxes of pillows having square end panels and four rectangular longitudinal panels, comprising: stacking the boxes on the pallet to substantially cover the surface of the pallet, with longitudinal panels of the boxes parallel to the longitudinal sides of the pallet and square end panels of the boxes parallel to the lateral sides of the pallet; wherein: all boxes have the same size and shape (dimensions); the longitudinal panels of each box each have a longitudinal length that is approximately ⅓ the length of the longitudinal side length of the pallet and each square side has a side length that is approximately ⅕ the lateral length of the pallet (thereby forming a stacked array of boxes with three longitudinal stack rows and five lateral stack columns).

Yet other aspects of the disclosure may include embodiments of a method of displaying a plurality of rectangular boxes of compressible bedding products on a store shelf having a front face, comprising: stacking boxes onto a shelf in two stacks of two boxes, with an outer stack and an inner stack; orienting the stacks so that one of the longitudinal side panels of each box in the outer stack faces outward from the shelf (approximately parallel to the front face of the shelf), and one of the longitudinal side panels of each box in the inner stack is approximately flush with the outer stack; wherein: each box has the same size and shape (dimensions); the shelf is approximately 23-24 inches deep; and the boxes have square end panels of about 9 inches and longitudinal panels with longitudinal length of about 30 inches. These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates an exemplary pallet loading system for compressible bedding products;

FIG. 2 illustrates the panels of an exemplary rectangular box;

FIG. 3A illustrates an exemplary pallet system with a composite image spanning four vertically adjacent boxes in a stack to create a billboard effect;

FIGS. 3B and 3C illustrate an exemplary pallet with the same billboard effect for a plurality of parallel stacks of boxes;

FIG. 4 illustrates an exemplary rectangular box of compressible bedding product, such as a mattress topper by way of example;

FIG. 5 illustrates stacking of two pallets within a truck trailer for transport;

FIG. 6 illustrates an exemplary pallet system for rectangular boxes of compressible pillows;

FIG. 7A illustrates a front elevation view of an exemplary shelf stacking system for rectangular boxes of compressible bedding products; and

FIG. 7B illustrates a side view of the exemplary shelf stacking system of FIG. 7A.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “box” means a relatively stiff or rigid (for example, not readily conforming, but maintaining its own shape independent of the product within it) enclosure (e.g. container) capable of being stacked; a box may be formed of any material capable of providing the necessary characteristics, such as cardboard or plastic by way of example;

The term “square” means a specific type of rectangle, in which all sides are approximately the same length (e.g. a quadrilateral with four right angles and four straight sides of approximately equal length);

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or approximately” or the like, when used with a number, may mean that specific number, or alternatively, a range in proximity to the specific number, as understood by persons of skill in the art field, for example +/−10%; and

If the specification states a component or feature “may,” “can,” “could,” “should,” “would,” “preferably,” “possibly,” “typically,” “optionally,” for “example,” “often,” or “might” (or other such language) be included or have a characteristic, that particular component or feature is not required to be included or to have the characteristic. Such component or feature may be optionally included in some embodiments, or it may be excluded.

FIG. 1 illustrates an exemplary embodiment of a pallet loading system. The system of FIG. 1 comprises a rectangular pallet 20 and a plurality of rectangular boxes 30. The pallet has longitudinal sides 22 and lateral sides 24 (with the longitudinal sides having greater length than the lateral sides). Each of the boxes 30 has the same shape and size (dimensions), with each having two square end panels 32 with equal square sides 33 and four rectangular longitudinal panels 36 with lateral sides 37 equal to the square sides 33 in length and longitudinal sides 38 (with length greater than the square sides). The longitudinal side 38 length of the boxes in FIG. 1 is approximately the same as the lateral side 24 length of the pallet, and the longitudinal side 22 length of the pallet in FIG. 1 is approximately the same as the longitudinal side 38 length of the boxes plus the square side 33 length of the boxes.

A lateral stack 50 of boxes 30 is located with an outer longitudinal panel 36a of each box in the lateral stack approximately flush in line/plane with (e.g. in proximity to) one of the lateral side 24 edges of the pallet 20. Additionally, a plurality of longitudinal stacks 60 of boxes 30 are each located with one of the square end panels 32 of the boxes in each longitudinal stack 60 approximately flush with the interior longitudinal panel 36b of the boxes in the lateral stack 50, and the longitudinal sides 38 of the boxes in the longitudinal stacks 60 extending perpendicular from the lateral stack 50 in (i.e. along and/or parallel to) the longitudinal side 22 length direction of the pallet 20 (so that the other square end panel 32 of the boxes in each longitudinal stack 60 is located in proximity (typically parallel) to the other lateral side 24 of the pallet 20 (i.e. the lateral pallet side that does not contain the lateral stack of boxes)). Also, each of the plurality of longitudinal stacks 60 of boxes 30 in FIG. 1 is flush against at least one adjacent longitudinal stack of boxes (with longitudinal panels flush).

In the system shown in FIG. 1, each stack 50 and 60 comprises the same number of boxes (for example, each stack might typically have 5 boxes). The pallet 20 in FIG. 1 is a standard pallet, having a longitudinal side 22 length of about 48 inches and a lateral side 24 length of about 40 inches. Additionally, each box 30 in FIG. 1 has square sides 33 with length of about 9 inches and longitudinal sides 38 with length of about 37 inches. In the embodiment of FIG. 1, the boxes 30 cover approximately 85-90% of the pallet surface 25 (for example, about 88%). In the system of FIG. 1, there is one lateral stack of boxes and four longitudinal stacks of boxes, such that the loaded pallet has 25 boxes.

Each box 30 in FIG. 1 may hold compressible bedding product 70 which has been compressed and rolled to fit within the box, as shown in FIG. 4. By compressing the product before or during rolling, the size and shape of the box may be altered (e.g. a different size and/or shape box may be selected since for example, the uncompressed product typically would not fit within the boxes sized as discussed above). Typically, the box for compressed product would take up less volume than a box for uncompressed product. For example, the compressible bedding product 70 might be a foam mattress topper. The mattress topper might be sized to fit any of the standard bed sizes (for example, twin, full, queen, or king), with the sleep surface of the topper approximately the same length and width as the corresponding bed mattress sleep surface, and might have a thickness of about 1-3 inches, 1.5-3 inches, 2-3 inches, 1-2 inches, 1.5-2.5 inches or 2-2.5 inches, by way of example. The mattress topper may comprise memory foam in some embodiments, but persons of skill will understand that the mattress topper might be formed of any type of foam or of any other compressible material. Oftentimes, the mattress topper might be formed of fairly high density foam, for example at least 3.0 pounds per cubic foot density. In other embodiments, the density of the mattress topper might be at least about 2.0 pounds per cubic foot, or range from 1.0 to 5.0 pounds per cubic foot, from 2.0 to 5.0 pounds per cubic foot, or from 3.0 to 5.0 pounds per cubic foot. Typically, the mattress topper might be compressed as it is rolled, for example with about 70 to 150 pounds of compression force or about 100 to 150 pounds of compression force, so that the diameter of the rolled mattress topper might fit into the box. Alternatively, the mattress topper might be held in its compressed state using about 60 to 100 pounds of compression force. Typically, the amount of compression during rolling might be determined based on the size and/or shape of the box (for holding the rolled mattress topper). So for example, for a box having 9×9 inch square end panels, the mattress topper might be rolled and compressed to have a cylindrical diameter of 9 inches of less. The length of the box would then be at least as long as the cylindrical length resulting from the rolled and compressed mattress topper. Oftentimes, the length of the box might be greater than the cylindrical length of the rolled compressed mattress topper, however, in order to better fit the dimensions of the pallet. While the diameter of the rolled topper might be about 9 inches in the embodiment of FIG. 1, in other similar embodiments the diameter might be 8 inches, 10 inches, 12 inches, 14 inches, or about 8-14 inches. And in FIG. 1, each box 30 optionally comprises an image spanning at least two longitudinal panels 36, so that the orientation of the boxes 30 in the stacks may produce an optional billboard effect (as described in more detail below).

Stacking the plurality of boxes onto the pallet (as shown in FIG. 1 for example) may be accomplished accordingly to the following exemplary method embodiment. As discussed above, the method involves a plurality of rectangular boxes 30 of compressible bedding products 70, with each box having two square end panels 32 and four rectangular longitudinal panels 36 having lateral sides 37 the same length as those of the square end panels 32 and longitudinal sides 38 with length greater than that of the lateral sides 37. Also, each of the boxes would typically be identically sized and shaped. And the pallet 20 would generally be a standard rectangular pallet having a top surface 25 and a perimeter with longitudinal sides 22 and lateral sides 24. The method embodiment of loading the pallet 20 might comprise stacking a lateral stack 50 of boxes onto the pallet 20 in proximity to one of the lateral sides 24 of the pallet; and stacking a plurality of longitudinal stacks 60 of boxes onto the pallet 20 in side-by-side (approximately flush) configuration. The lateral stack 50 would be placed so that one of its longitudinal panels 36 is approximately flush with the lateral side 24 edge of the pallet. The longitudinal stacks 60 would be oriented so that one of the square end panels 32 of each box on each longitudinal stack 60 would be approximately flush with the lateral stack 50, with the longitudinal panels 36 of each box 30 in each longitudinal stack 60 extending perpendicularly therefrom in the longitudinal direction on the pallet 20. Typically, each box 30 would have longitudinal sides 38 approximately equal in length to the lateral sides 24 of the pallet 20, and each box 30 would have square end panels 32 sized so that the length of one square end panel side 33 of the box plus the length of one longitudinal side 38 of the box is approximately equal to the longitudinal side 22 length of the pallet 20. By sizing the boxes in this manner (e.g. in proportion to the pallet) and configuring the stacks of boxes in this manner (e.g. with one lateral stack and a plurality of longitudinal stacks), the plurality of boxes may be efficiently stacked on the pallet, thereby increasing the product density of each pallet (by about 40%, for example). This in turn may significantly reduce freight costs for transportation of the boxed products, for example up to about 40%. Again, the box size and shape may only be made possible by compressing the compressible bedding product (so selection of the amount of compression and the size of the boxes may be important to increasing product density).

Stated another way, an exemplary method embodiment of efficiently loading a plurality of rectangular boxes of compressible bedding products, with each box having two square end panels and four rectangular longitudinal panels having lateral sides the same length as those of the square end panels and longitudinal sides with length greater than that of the lateral sides and each box being identically sized and shaped, onto a rectangular pallet having (a top surface and) a perimeter with longitudinal sides and lateral sides, may comprise: placing/stacking/positioning a lateral stack 50 of boxes onto the pallet 20 with an outer one of the longitudinal panels 36 of each box in the lateral stack 50 approximately flush in line/plane with (and in proximity to) and extending along one of the lateral side 24 edges (plane) of the perimeter of the pallet 20; and placing/stacking/positioning a plurality of longitudinal stacks 60 of boxes onto the pallet 20 with one square end panel 32 of each box in each longitudinal stack 60 interfacing approximately flush with (and/or in proximity to) an inner one of the longitudinal panels 36 of an adjacent box in the lateral stack 50 and longitudinal panels 36 extending perpendicular from the interface with the lateral stack 50 (in the direction of the longitudinal side 22 length of the pallet 20). Each of the plurality of longitudinal stacks 60 of boxes may also be approximately flush (e.g. with adjacent longitudinal panels flush) against one or more adjacent longitudinal stacks. And, each box typically would have longitudinal sides approximately equal in length to the lateral sides of the pallet, and square end panels sized so that the length of one square end panel side of the box plus the length of one longitudinal side of the box is approximately equal to the longitudinal side length of the pallet. Typically, each stack would comprise the same number of boxes. The result of such a stacking approach would be a loaded pallet as shown for example in FIG. 1.

It should be understood that the order of stacking the lateral stack and the longitudinal stacks may be arbitrary. So for example, all longitudinal stacks could be placed on the pallet first, followed by the lateral stack, or the lateral stack could be placed first, followed by the longitudinal stacks. And in some embodiments, the longitudinal stacks might not all be placed at the same time. So for example, two longitudinal stacks might be placed, followed by the lateral stack, with the remaining longitudinal stacks then being placed on the pallet. In fact, the boxes might not be moved onto the pallet in stacks per se, but rather each horizontal layer of boxes might be oriented before the next horizontal layer of boxes is oriented, ultimately resulting in stacks as shown in FIG. 1. Regardless of the specific order of stacking/orienting/positioning boxes, the stacks of boxes are place/stacked/positioned on the pallet (so that the two method embodiments described above include any such stacking regardless of specific order). These and other ways of placing boxes in stacks on the pallet are included within the scope of this disclosure, so long as a loaded pallet according to the embodiment of FIG. 1 (e.g. with boxes oriented in stacks as shown) is produced, for example. In other words, placing/stacking/positioning stacks of boxes may be accomplished in some embodiments by building up multiple stacks at once using horizontal layers. Thus, another way to describe the exemplary method of stacking boxes onto a pallet might be based merely on the final stacked pallet configuration. Stated another way, the method might comprise stacking a plurality of boxes onto a pallet, wherein the pallet is ultimately loaded with a lateral stack of boxes and a plurality of longitudinal stacks of boxes. For example, the method might include stacking a plurality of boxes onto a pallet, wherein the rectangular pallet has longitudinal sides and lateral sides; the plurality of rectangular boxes each have two square end panels with equal square sides and four rectangular longitudinal panels with lateral sides equal to the square sides in length and longitudinal sides (with length greater than the square sides), and wherein the longitudinal side length of the boxes is approximately the same as the lateral length of the pallet and the longitudinal length of the pallet is approximately the same as the longitudinal length of the boxes plus the square side length of the boxes; each box has the same shape and size (dimensions); a lateral stack of boxes is located with an outer longitudinal panel of each box in the lateral stack approximately flush in line/plane with one of the lateral side edges of the pallet; a plurality of longitudinal stacks of boxes are each located with one of the square end panels of the boxes in each longitudinal stack approximately flush with the interior longitudinal panel of the boxes in the lateral stack and the longitudinal sides of the boxes in the longitudinal stacks extending perpendicular from the lateral stack in (i.e. along and/or parallel to) the longitudinal length of the pallet (so that the other square end panel of the boxes in each of the longitudinal stacks is located in proximity (typically parallel) to one of the lateral sides of the pallet); and each of the plurality of longitudinal stacks of boxes are flush against at least one adjacent longitudinal stack of boxes (with longitudinal panels flush).

Additionally, such methods may include the step of selecting box size and shape based on pallet dimensions and/or compressibility of the bedding product, and selecting the amount of compression of the bedding products (to provide box size and shape for increasing product density on pallet without negatively impacting bedding product after removal from box). In other words, by compressing the bedding product (such as a mattress topper), the size of the box needed to contain the rolled product may be altered in a way that allows for increasing product density on the pallet. For example, the end panels of the boxes may be reduced in dimension (for example, down from 15 inches by 15 inches to about 9 inches by 9 inches), while the longitudinal panels of the boxes may be extended in length (for example from 18 inches to about 37 inches). Typically, compression of the product allows for use of a box having smaller volume. So compression of the bedding product may allow the box dimensions to be better sized to fit within the constraints of the pallet dimensions (for example, the longitudinal panels may have a longitudinal length that is approximately the same as the lateral length of the pallet, and the square end side length plus the longitudinal length of the boxes may be approximately the same length as the longitudinal length of the pallet). And fitting the product into a smaller box (for example, with a smaller volume) may help increase product density on the pallet. By sizing the boxes in this manner, the lateral stack can approximate the lateral pallet length along one edge of the pallet and the longitudinal stacks can extend from the lateral stack along the lateral length of the pallet to approximately reach the other lateral side of the pallet (thereby stacking boxes on the pallet surface in a way that covers the majority of the pallet surface, seeking to minimize unused pallet surface).

Typically, the bedding products would be compressed, rolled, and somehow retained (for example, held in the compressed rolled state via a strap, a wrapping, or some other retaining means). The compressed and rolled bedding products might then be inserted into boxes. As discussed above, the compressed rolled bedding products would fit into the boxes, but uncompressed bedding products would not fit into the boxes (such that the compression makes the bedding products operable to fit into the boxes sized with respect to the pallet dimensions). The bedding products are then operable to expand once removed from the boxes and un-retained, returning to their original uncompressed and unrolled dimensions for use by the end user consumer. Typically, the compression of the bedding product would be in the thickness dimension, so that the rolled bedding product would fit within a box with smaller square end panels (than would be possible for uncompressed product). Such compression might increase the length of the box needed to contain the compressed product, but the volume of the box would typically be significantly reduced (for example about 20-30% less volume, or in some embodiments perhaps up to about 40% less).

So, when the method of stacking is employed, the plurality of boxes generally covers substantially all of the pallet surface, for example approximately 85-90%, 85-95%, or 80-95% of the pallet surface in various embodiments. Stated another way, the amount of the pallet surface uncovered by boxes in any direction might range from about 0 to 5%, 0 to 7.5%, 0 to 10%, 4 to 7.5%, 5 to 7.5%, 5 to 10% and/or 7.5 to 10%. Typically, the pallet of FIG. 1 has longitudinal length of about 48 inches and lateral length of about 40 inches; and the boxes of FIG. 1 each have a longitudinal length of approximately 37 inches and square end panel side length of approximately 9 inches. Each stack may be stacked with 5 boxes (since this height may allow for transport on trucks built for standard pallets, for example allowing two pallets to be stacked in the truck (see FIG. 5 for example) to maximize product transportation per truck. As shown in FIG. 1, there may be four longitudinal stacks, such that 25 boxes may be stacked on each pallet. The boxes may be retained onto the pallet (with straps or plastic wrapping, etc.), so that the loaded pallet (with the plurality of boxes) may be moved as a unit. Two loaded pallets may be stacked onto a truck (trailer) bed (typically with a number of such stacks loaded onto the truck in an attempt to maximize the available space for transport). Typically, the compressible bedding products of FIG. 1 might be mattress toppers.

In some embodiments, each box may comprise an image spanning at least two of the longitudinal panels, and two or more boxes may be oriented in a stack for a billboard effect (as shown in FIG. 1 for example, and described in more detail below). Stated another way, the image on each of the boxes in FIG. 1 might be a composite image 100 formed of at least two subimages 110 and 120, with the at least two subimages located on sequential longitudinal panels 36c and 36d of each of the boxes 30 (as shown in FIG. 2 for example). Rotation (or orientation) of vertically adjacent boxes 30a and 30b in a stack (for example, on a pallet or shelf) forms the billboard effect by displaying the subimages 110 and 120 on sequential longitudinal panels 36c and 36d (in a plane) to form the composite image 100 spanning the at least two boxes 30 in the stack. It should be understood that up to four subimages might be used for the billboard effect in some embodiments, with the four longitudinal panels each containing one of the subimages in sequential order.

While each stack in FIG. 1 could employ billboard effect to display one or more composite images on its own, multiple parallel stacks (typically flush against one another) could also be arranged to work together so that, as boxes are removed from the pallet, the composite image may still be displayed by using the combination of the subimages in the outer stack with the subimages on revealed boxes of one or more inner stacks. Typically, in FIG. 1 the boxes would be stacked in multiple parallel longitudinal stacks flush against one another, with each longitudinal stack having boxes oriented in the same way/pattern forming the billboard effect. That way if a box is removed from an outer longitudinal stack, the composite image still might be displayed (when viewed from a distance for example) based on subimages on a combination of boxes from the outer longitudinal stack and one or more revealed inner longitudinal stacks (as shown for example, in FIGS. 3A-3C). Such an image 100 (with multiple subimages on sequential longitudinal panels of the box) could be formed on the boxes 30 in any number of ways. For example, the composite image could be formed on the boxes via litholaminate process, or in other embodiments, the image could be formed on the boxes via an enwrapping sleeve about each boxes longitudinal panels.

An alternative pallet loading system (for efficient loading of boxed product onto a pallet) might be needed for pillows (since pillows are much smaller than a mattress topper, for example). Such a pillow pallet loading system is shown in FIG. 6, and exemplary embodiments might comprise: a pallet 720 having a surface 725, two laterals sides 724 and two longitudinal sides 722, and a plurality of rectangular boxes 730, each box have the same size and shape (dimensions) with two square end panels 732 and four longitudinal panels 736 and containing a pillow 790. Typically, for pillows the boxes would be smaller than for other compressible bedding products (such as mattress toppers). For example, the longitudinal panels 736 of the boxes each might have a longitudinal side that is approximately ⅓ the longitudinal side 722 length of the pallet and a lateral side (the same length as the sides of the square end panels) that is approximately ⅕ the lateral side 724 length of the pallet. So for example, each pillow box might have square sides of about 7.5 inches and a longitudinal length of about 15.5 inches. The boxes 730 of pillows would be stacked on the pallet 720 to substantially cover the surface 725 of the pallet (for example, in a way that maximizes the number of boxes per pallet). For example, the longitudinal panels 736 of the boxes in FIG. 6 are oriented parallel to the longitudinal sides 722 of the pallet, and the square end panels 732 are oriented parallel to the lateral sides 724 of the pallet. So in FIG. 6, the boxes of pillows are formed up on the pallet in a stacked array with three longitudinal stack rows 750 and five lateral stack columns 760. Additionally, each stack of boxes in FIG. 6 includes six boxes, such that ninety boxes of pillows are arranged on the pallet.

Typically, the pillows (which could include any compressible material but typically might comprise foam) would be compressed to fit into the boxes, allowing for differently sized and shaped boxes to be used to increase the product density per pallet (since uncompressed pillows would not fit into the boxes described above for FIG. 6). In other words, this compression of the pillow allows for use of differently sized and shaped boxes, which in turn may allow for increased product density on the pallet (due to smaller volume boxes and/or the ability to stack boxes in a different configuration due to differently shaped boxes to better utilize the surface of the pallet (e.g. make more effective use of the footprint of the pallet). Thus, selection of the amount of compression of the pillows (or other compressible products) and/or the shape and/or size of the boxes may be a step of the method. Straps, plastic wrapping, or other retaining means may be used to retain the boxes onto the pallet, so that the loaded pallet can be moved as a unit without fear of any boxes falling off the pallet. In some embodiments, two or more of the boxes in a stack may have images and be oriented to display a billboard effect (as discussed above).

An exemplary pillow pallet might be loaded using the following exemplary method embodiment. Specifically, a plurality of boxes might be stacked on the pallet to substantially cover the surface of the pallet, with longitudinal panels of the boxes parallel to the longitudinal sides of the pallet and square end panels of the boxes parallel to the lateral sides of the pallet. Typically, all boxes would have the same size and shape (dimensions), and the longitudinal panels of each box each might have a longitudinal length that is approximately ⅓ the length of the longitudinal side length of the pallet and each square side of the boxes might have a side length that is approximately ⅕ the lateral length of the pallet (thereby forming a stacked array of boxes with three longitudinal stack rows 750 and five lateral stack columns 760).

Stated another way, method embodiments might include stacking the boxes on the pallet to substantially cover the surface of the pallet so that three stacks (rows) of boxes are oriented with longitudinal sides extending parallel to the longitudinal length of the pallet and five stacks (columns) of boxes are oriented with square end panels extending parallel to the lateral length of the pallet. Again, all boxes typically would have the same size and shape (dimensions), with the longitudinal side of each box typically being approximately ⅓ the length of the longitudinal side length of the pallet and each square side typically being approximately ⅕ the lateral length of the pallet. Still another way to consider method embodiments might include stacking the boxes on the pallet to substantially cover the surface of the pallet so that three boxes span the longitudinal side length of the pallet (with longitudinal side length of the three boxes extending along the longitudinal side of the pallet) and five boxes span the lateral side length of the pallet (with square end panels extending along the lateral side length of the pallet).

Typically, each stack might comprise six boxes, and each box would have square sides of about 7.5 inches and longitudinal length of about 15.5 inches. The methods might further comprise compressing the pillows to fit into the boxes. Typically, the pillows comprise foam, which may be compressed to fit in the box without altering the uncompressed characteristics of the pillow (so that once the pillow is removed from the box and uncompressed, it would return to about its original size, shape, and supportiveness (e.g. IFD). Typically 90 such boxes would be stacked on the pallet, as shown in FIG. 6. And in some embodiments, at least two boxes in a stack would have a composite image and be oriented to create a billboard effect, as discussed above.

Various embodiments might comprise compressing a plurality of identical compressible bedding product (which for example might all be pillows, mattress toppers, or mattresses) to fit in boxes (which are smaller in volume and/or shaped differently than possible using the uncompressed product); and stacking the boxes of product (for example, on a pallet or shelf) and/or orienting the stacks to approximately cover the available surface (for example, of the pallet or shelf). The box size and shape could be selected based on the amount of compression that the bedding product can undergo and recover to approximately its original size and shape (e.g. without negatively impacting its IFD) once the compression is removed and the dimensions of the pallet. Additionally, the box might be sized in proportion to the pallet (or other surface) in some embodiments. The goal might be to select the size and shape and orientation of boxes that would allow for maximizing product density on the pallet (for example, to cover as much of the pallet surface as possible and/or to place as many products on the pallet as possible). Another goal might be to select the size and shape of the boxes so that when the boxes are all stacked on the pallet, they form a continuous block (so for example, there may be no significant holes or gaps between the boxes atop the pallet). The block of boxes typically would have bottom surface dimensions that approximate those of the surface of the pallet (typically no more than 10% smaller than the dimensions of the pallet, for example). Typically, the boxes would also be oriented in a way that stacks the boxes on a longitudinal panel side, since for example this may result in more stable pallet stacking and/or may better serve for billboard effect. And typically, the boxes would be rectangular, with square side end panels and longitudinal side panels for example (although in other embodiments, other box shapes, such as squares, might be used). The boxes may also be stacked into a plurality of stacks, which typically may be oriented parallel to one of the sides of the pallet. FIG. 1 illustrates one specific embodiment, while FIG. 6 shows another such embodiment (with the size and shape of the boxes and orientation of the stacks differing, for example, due to the differences in the products within the boxes).

While the bulk of this disclosure has dealt with systems and method for use with pallets (for transportation and display of products), Applicant has also recognized that some of the same principles might be employed to increase product density for display on shelves (or other surfaces) in stores, for example. Specifically, by compressing the bedding product, the size and/or shape of the boxes for containing the bedding product (such as a mattress topper) might be altered to allow for improved stacking of boxed product on store shelves. Increasing product density on shelves may reduce the need for warehousing of products, allow for increased time between restocking, and/or make more product actually available at point-of-purchase to help increase sales.

Such an exemplary shelf loading system embodiment is shown in FIGS. 7A and 7B and may comprise: two or more vertically stacked shelves 815 having a front face 818, a depth (d) of about 23-24 inches, a width (w) of at least 30 inches, and the shelves 815 being separated vertically by, for example, height (h) more than about 18 inches but typically less than about 27 inches; and a plurality of rectangular boxes 830 of compressible bedding products each having square end panels 832 and four longitudinal side panels 836. On each shelf 815 (that is, for each 30 horizontal inches of shelf space), four boxes 830 may be stacked in two stacks of two boxes, with an inner stack 860 and an outer stack 850. The stacks of FIGS. 7A and 7B are oriented so that a longitudinal panel 836 of each box in the outer stack 850 faces outward from the shelf for display in proximity to the front face 818 of the shelf (approximately parallel to the front face of the shelf), and one of the longitudinal panels 836 of each box in the inner stack 860 is approximately flush with the outer stack 850 (i.e. the inner facing longitudinal panel of the adjacent box in the outer stack). Typically, each box has the same size and shape, for example with the square end panels of FIGS. 7A and 7B having square sides about 9 inches in length, and the longitudinal side panels having longitudinal sides of about 30 inches in length. Typically, the compressible bedding product (such as a mattress topper) would be compressed and rolled so that it will fit in the box with the new dimensions.

So an exemplary method embodiment of loading shelves might comprise: stacking boxes onto a shelf in two stacks of two boxes, with an outer stack and an inner stack; orienting the stacks so that one of the longitudinal side panels of each box in the outer stack faces outward from the shelf (approximately parallel to the front face of the shelf), and one of the longitudinal side panels of each box in the inner stack is approximately flush with the outer stack; wherein: each box has the same size and shape (dimensions); the shelf is approximately 23-24 inches deep; and/or the boxes have square end panels of about 9 inches and longitudinal panels with longitudinal length of about 30 inches. Typically, the compressible bedding product would be compressed (for example to allow the products to fit into smaller volume boxes with smaller side end panels), and the box size and/or shape would be selected to increase product density on the shelf. It should be understood that the order of stacking boxes may be considered arbitrary in some embodiments. All stacking methods resulting in the box stack configuration of FIG. 7A are intended to be included.

In FIG. 7A, the bedding product is a mattress topper (typically comprising foam). The topper may be compressed and rolled to fit within the box. Typically, compressing the bedding product before rolling allows for use of a differently sized and/or shaped box, which can be important to the stacking system for increasing product density on the shelf. For example, by elongating the box and having a smaller square end panel, it may be possible to place two stacks of boxes on the shelf, with an inner stack behind the outer stack. By selecting the dimensions of the box appropriately (for example, based on the dimensions (such as the depth) of the shelf and/or the compressibility of the bedding product), the footprint of the shelf (surface) may be more effectively utilized. The topper of FIG. 7A generally has an uncompressed thickness of about 2.5 inches or less, so that the compressed topper may fit within the box. The exemplary mattress topper details discussed above for other embodiments may also apply for this embodiment as well.

So in some embodiments, selecting the amount of compression of the bedding products and/or selecting the size and/or shape of the box may be an important step in the method. In some embodiments, the boxes in each stack may have an image and be oriented to form a billboard effect (displaying a composite image across two boxes based on each box having subimages on different longitudinal panels). If billboard effect is used, the boxes of the inner stack typically might have the same orientation as those in the outer stack (so that even when one of the boxes in the outer stack is removed, the composite image might be displayed based on the revealed box of the inner stack in conjunction with the remaining box of the outer stack). In other embodiments, the shelves might be separated by more than 27 inches (with typical additional increments of at least 9 inches, for example 9-10 inches), allowing for additional boxes to be added to the stacks (e.g. the stacks, for example the inner stack and the outer stack, might be more than two boxes high). And if the shelves extend horizontally more than 30 inches (or the longitudinal length of the boxes), the stacking system may be employed repetitively along the horizontal length (for example, with the number of outer stacks being equal to about the horizontal length of the shelves divided by the longitudinal length of the boxes (and typically rounded down, and with the number of inner stacks equaling the number of outer stacks on the shelf). Applicants believe that such a system of stacking compressible bedding products onto shelves could result in approximately double product displayed on each shelf (e.g. approximately double the product density as previously available).

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as comprises, includes, and having should be understood to provide support for narrower terms such as consisting of, consisting essentially of, and comprised substantially of Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method of efficiently loading a plurality of rectangular boxes of compressible bedding products, with each box having two square end panels and four rectangular longitudinal panels having lateral sides the same length as those of the square end panels and longitudinal sides with length greater than that of the lateral sides and each box being identically sized and shaped, onto a rectangular pallet having a perimeter with longitudinal sides and lateral sides, the method comprising:
positioning a lateral stack of boxes onto the pallet with an outer one of the longitudinal panels of each box in the lateral stack approximately flush in line with and extending along one of the lateral side edges of the perimeter of the pallet;
positioning a plurality of longitudinal stacks of boxes onto the pallet with one square end panel of each box in each longitudinal stack interfacing approximately flush with an inner one of the longitudinal panels of an adjacent box in the lateral stack and longitudinal panels extending perpendicular from the interface with the lateral stack;
wherein each of the plurality of longitudinal stacks of boxes is also flush against one or more adjacent longitudinal stacks; and
wherein each box has longitudinal sides approximately equal in length to the lateral sides of the pallet, and each box has square end panels sized so that the length of one square end panel side of the box plus the length of one longitudinal side of the box is approximately equal to the longitudinal side length of the pallet.

2. The method of claim 1 wherein each stack comprises the same number of boxes.

3. The method of claim 1 further comprising selecting box size and shape based on pallet dimensions and compressibility of the bedding product, and selecting the amount of compression of the bedding products.

4. The method of claim 1 further comprising compressing the bedding products, rolling the bedding products, retaining the rolled bedding products, and inserting the rolled bedding products into boxes.

5. The method of claim 4 wherein the compression allows the bedding product, which previously would not fit within the box, to now fit in the box.

6. The method of claim 1 wherein the plurality of boxes cover approximately 85-90% of the pallet surface.

7. The method of claim 1 wherein the pallet has longitudinal length of about 48 inches and lateral length of about 40 inches; and wherein the boxes each have a longitudinal length of approximately 37 inches and square end panel side length of approximately 9 inches.

8. The method of claim 1 wherein the amount of the pallet surface uncovered by boxes in any direction ranges from about 0 to 5%, 0 to 7.5%, 0 to 10%, 4 to 7.5%, 5 to 7.5%, 5 to 10% and/or 7.5 to 10%.

9. The method of claim 2 wherein each stack comprises 5 boxes.

10. The method of claim 9 wherein the plurality of longitudinal stacks of boxes comprises four longitudinal stacks; and wherein 25 boxes are stacked on each pallet.

11. The method of claim 1 wherein two loaded pallets are stacked onto a truck bed.

12. The method of claim 1 wherein the compressible bedding products are mattress toppers; the method further comprising retaining the boxes onto the pallet; and wherein each box comprises an image spanning at least two of the longitudinal panels, the method further comprising orienting two or more boxes in a stack for a billboard effect.

13. A pallet loading system comprising:
a rectangular pallet having longitudinal sides and lateral sides;
a plurality of rectangular boxes each having two square end panels with equal square sides and four rectangular longitudinal panels with lateral sides equal to the square sides in length and longitudinal sides, and wherein the longitudinal side length of the boxes is approximately the same as the lateral length of the pallet and the longitudinal length of the pallet is approximately the same as the longitudinal length of the boxes plus the square side length of the boxes;
wherein:
each box has the same shape and size;
a lateral stack of boxes is located with an outer longitudinal panel of each box in the lateral stack approximately flush in line with one of the lateral side edges of the pallet;
a plurality of longitudinal stacks of boxes are each located with one of the square end panels of the boxes in each longitudinal stack approximately flush with the interior longitudinal panel of the boxes in the lateral stack and the longitudinal sides of the boxes in the longitudinal stacks extending perpendicular from the lateral stack; and
each of the plurality of longitudinal stacks of boxes are flush against at least one adjacent longitudinal stack of boxes.

14. The system of claim 13 wherein each stack comprises the same number of boxes.

15. The system of claim 14 wherein the pallet has longitudinal length of about 48 inches and lateral length of about 40 inches, each box has square sides with length of about 9 inches and longitudinal sides with length of about 37 inches, and each stack comprises 5 boxes.

16. The system of claim 13 wherein the boxes cover approximately 80-95% of the pallet surface.

17. The system of claim 15 wherein there are four longitudinal stacks of boxes, and wherein the loaded pallet has 25 boxes.

18. The system of claim 13 wherein each box comprises compressible bedding product compressed and rolled to fit within the box.

19. The system of claim 18 wherein the compressible bedding product comprises a foam mattress topper.

20. The system of claim 18 wherein each box comprises an image spanning at least two longitudinal panels, and the orientation of the boxes in the stacks produces a billboard effect.
